(19) United States
(12) Patent Application Publication
(10) Pub. No.: US 2004/0172369 A1
(43) Pub. Date: Sep. 2, 2004

(54) Method and arrangement in a database

(76) Inventor: Jonas Persson, Solna (SE)

Correspondence Address: NIXON PEABODY, LLP, 401 9TH STREET, NW, SUITE 900, WASHINGTON, DC, 20004-2128, US

(21) Appl. No.: 10/471,844

(22) PCT Filed: Feb. 27, 2002
(86) PCT No.: PCT/SE02/00336

(30) Foreign Application Priority Data
Mar. 16, 2001 (SE) 0100916-6

(51) Int. Cl. G06F 17/60

(52) U.S. Cl. 705/67

(57) ABSTRACT

The present invention relates to a smart card based registry database and is a database in which mobile terminal applications, SIM card based applications, PDA applications etc all can gain access, create new entries, read already stored information or update old information etc. How the information is used is up to the application, the registry only stores the information The registry comprises security such as authentication and encryption and can be used to improve existing applications.

### FIELD OF THE INVENTION

The present invention relates to a method and arrangement in a database in accordance with the preambles of the independent claims. More specifically it relates to a secure smart card registry database.

### BACKGROUND OF THE INVENTION

In the Windows™ environment there is a registry database containing information used by various applications from different vendors. Everyone has access to the registry. Everyone can read and write in the different entries as they please. However, such a public registry database is not suitable for storing of confidential data or data that not is intended to be cloned.

To attain security in open networks, several security solutions have appeared. One example is Public Key Infrastructure (PKI). PKI is a system used to distribute and check public keys that can be used to authenticate users, sign information or encrypt information. In a PKI system, two corresponding (also called asymmetric) keys are used in connection with protecting information. Information, which is encrypted with one of the two keys, can be decrypted only with the other key. One important feature of PKI systems is that it is computationally unfeasible to use knowledge of one of the keys to deduce the other key. In a typical PKI system, each of the systems possesses a set of two such keys. One of the keys is maintained private while the other is freely published.

A PKI distributes one or several public keys and determines whether a certain public key can be trusted for certain usage or not. An important concept in infrastructures built on public key cryptography is that of the Certification Authority (CA). The weakness in a public key system is that, even though it is desirable that the public keys for all users are easily available, it is also required to assert that it is truly known that a particular public key really belongs to the user that one is communicating with. This is what a CA is used for. It uses its good name to guarantee the correctness of a public key by signing a key.

What is further needed is a way of using PKI for storing data in a public registry database.

In cellular radio systems environments like the Global System for Mobile Communications (GSM), there is a Subscriber Identity Module (SIM) card that contains information required by a mobile phone to establish a call. The SIM card also contains information used by the user, such as Abbreviated Dialling Number (ADN) lists, Short Message Service (SMS) storage etc.

An external device such as a Personal Digital Assistant (PDA) can access the SIM card through a mobile phone's serial or Infrared Data Association (IrDA) port etc by using AT commands or mobile phones proprietary commands. (An AT command is a command language developed by Hayes Microcomputer Products, Inc. to control auto-dial modems from a dumb asynchronous terminal or a PC emulating such a terminal.) The devices can use all the SIM card commands such as CreateFile, UpdateBinary etc if the right PIN codes have been presented.

If there is an application on the mobile phone or the SIM such as WAP browser or SIM browser these can also access the SIM card. A disadvantage is that these programs (or the creator of the program) must know how to communicate with SIM card, which means that the SIM card commands from different SIM card manufacturers must be known. Also the administrative codes for each SIM card must be known if a new file is to be created. This is almost impossible.

### SUMMARY OF THE INVENTION

The object of the present invention is to provide a smart card registry database where mobile terminal applications, SIM card based applications, PDA applications etc all can access this database, create new entries, read already stored information or update old information in a way of improved security.

The above-mentioned object is achieved by a method and a system according to the characterising part of the independent claims.

The smart card registry database provided by the present invention, comprising means for

creating an entry, which entry is associated with a root certificate, and which root certificate is signed and issued by a Certification Authority (CA);

receiving a request for accessing the created entry in the registry from any user application, said request comprising a certificate issued and signed by said CA, said certificate including a public key, said public key corresponding to a private key that said any user application owns;

using the obtained public key for challenging said any user application;

receiving a response of said challenge, encrypted by a private key of said any user application;

giving said any user application (106) access if the challenge response is successful,

makes it possible for any user application (106) to create an entry, which entry is accessible only for, by said any user application, selected user applications which implies improved security.

The method provided by the present invention comprising the steps of

creating an entry in the smart card registry database, which entry is associated with a toot certificate, and which toot certificate is signed and issued by a Certification Authority (CA);

any user application sending a request for access to the created entry in the registry, said request comprising a certificate issued and signed by the CA, said certificate including a public key, said public key corresponding to a private key that said any user application owns;

the registry (104) challenging said any user application by means of the obtained public key;

said any user application responding said challenge by means of its said private key and returning it to the registry;

if the challenge response is successful, giving said any user application (106) access to the created entry,

makes it possible for any user application to access this database, create new entries, read already stored information or update old information in a way of improved security.

An advantage with the present invention is that it makes it possible to store tickets, medical data etc. in a mobile phone in a secure way.

Preferred embodiments are set force in the dependent claims.

According to a first embodiment of the present invention, a value to be stored is combined with a certificate, which is retrieved from the registry, and the combination is signed by a user application and the signed value-certificate is stored in the smart card registry database.

An advantage with the first embodiment is that it can be checked by any user application reading the stored value whether the value is copied or manipulated.

### BRIEF DESCRIPTION OF THE DRAWINGS

FIG. 1 shows an exemplary scenario wherein the registry according to the present invention is used.

FIG. 2a is a signalling sequence diagram showing an example of how to create an entry in the registry.

FIG. 2b is a signalling sequence diagram showing how to store data in a created entry in the registry.

FIG. 2c is a signalling sequence diagram showing how to read data in a created entry in the registry.

FIG. 3a is a signalling sequence diagram showing an example of how to create an entry with an associated certificate in the registry.

FIG. 3b is a signalling sequence diagram showing how to store data in a created entry with an associated certificate.

FIG. 3c is a signalling sequence diagram showing how to read data in a created entry with an associated certificate.

FIG. 4a is a signalling sequence diagram showing how to store a value, in a way that the value is protected against copying and manipulating.

FIG. 4b is a signalling sequence diagram showing how to find out that a read copy-protected value in the registry it is not copied or manipulated.

### DETAILED DESCRIPTION OF PREFERRED EMBODIMENTS

The smart card based registry database according to the present invention and further on called the registry, is a database to which mobile terminal applications, SIM card based applications, PDA applications etc all can gain access, create new entries, read already stored information or update old information etc. How the information is used is up to the application, the registry only stores the information. The registry. comprises security such as authentication and encryption and can be used to improve existing applications.

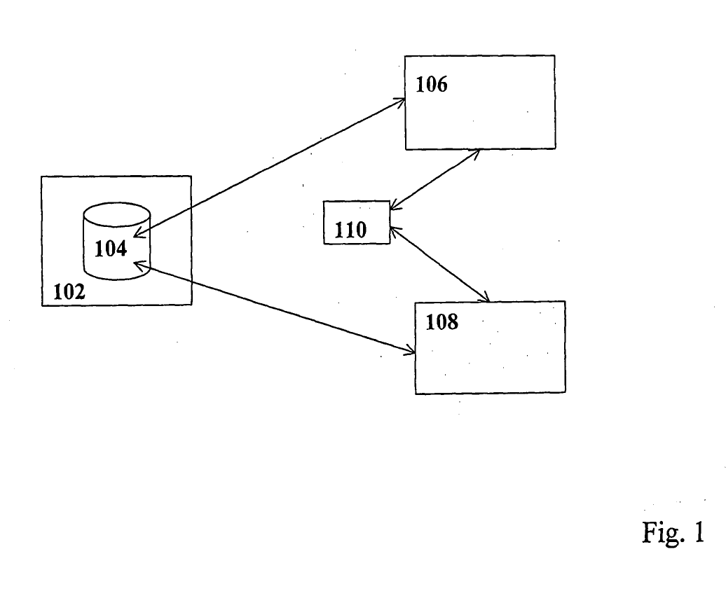

FIG. 1 Shows an exemplary scenario wherein the registry according to the present invention is used. A smart card unit 102 comprising the registry 104 is accessible by one or more user applications, within this scenario by a first user application 106 and a second user application 108. The smart card 102 may be comprised e.g. in a portable unit such as a mobile phone, or PDA. The user application 106 is e.g. a mobile terminal application, a SIM card based application, a PDA application an electronic ticket application etc. that wishes to use the registry 104 for a safe storing of data. For example a person that wants to see a movie uses the WAP browser in his mobile phone to browse to a ticket-issuing unit within electronic cinema ticketing system and orders a ticket to the movie. He pays e.g. electronically. The first user application 106 in the ticket-issuing unit stores the electronic ticket in a registry 104 in the SIM card, i.e. a smart card 102, within the user's mobile phone. When the person comes to the cinema he connects to a ticket-receiving unit within the electronic cinema ticketing system via Bluetooth™ or IrDA or something else. The second user/application 108 within the ticket-receiving unit searches for the relevant ticket in the registry 104 and validates it.

Security The registry database is open for anyone but anyone has not access to all registry entries. An entry is defined as a “storage location” in the registry 104. The registry 104 is based on public key cryptography, e.g. on asymmetric encryption/decryption and signing, to attain security in the system. A certificate comprising a public key is stored in the registry 104. This certificate may be down loaded by any user application that requires protection for data to be stored in the registry 104. In the registry there is also a private key that corresponds to the public key in said certificate.

A first user application 106, that requires using the registry 104 for storing some data, creates an entry to the registry 104. If required, the first user application. 106 has a possibility to restrict who shall be granted access to the created entry. If so, one or more so called toot certificates are assigned to the entry. The owner of the root certificate is considered a local certification authority (CA) 110. This local CA 110 can be any entity, e.g. a user application 106. The purpose of the local CA 110 is to issue certificates. These certificates are used by different entities in the system. When the second user application 108 wants to read the information in the registry 104 it has to present a valid certificate that has been issued by the local CA 110 to the registry 104. The registry 104 then challenges the second user application 108. If the second user application 108 responses successfully to the challenge then access to the registry 104 is granted.

It is possible for a user application 106; 108 to add and remove root certificates to the created entry that grant access to the registry database.

It is further possible for the user application 106, 108 to make the choice to encrypt the data to be stored if so required.

It is also possible for the user application 106, 108, to make sure that the stored content is not copied, e.g. to another smart card registry. This is achieved with a certificate stored in the registry 104. The first user application 106 asks for a certificate from the registry 104. The data to be stored is combined with the newly received certificate and then signed by the first user application 106. The second user application 108 reads the stored information from the registry 104. The second user application 108 can now make sure that the content has not been copied by challenging the registry 104. The second user application 108 can also make sure that the stored data has not been manipulated by examining the first user application 106 signature.

To sum up, there are three levels of security of created entries in the registry 104.

First, when creating the entry without any restrictions, anyone is granted access to this entry.

Secondly, when associating one or more certificates to the created entry, only those who have got a valid certificate and are the owner of the certificate will be granted access to the entry when authorised.

Thirdly, using digital signatures to make sure that the data has not been manipulated or copied.

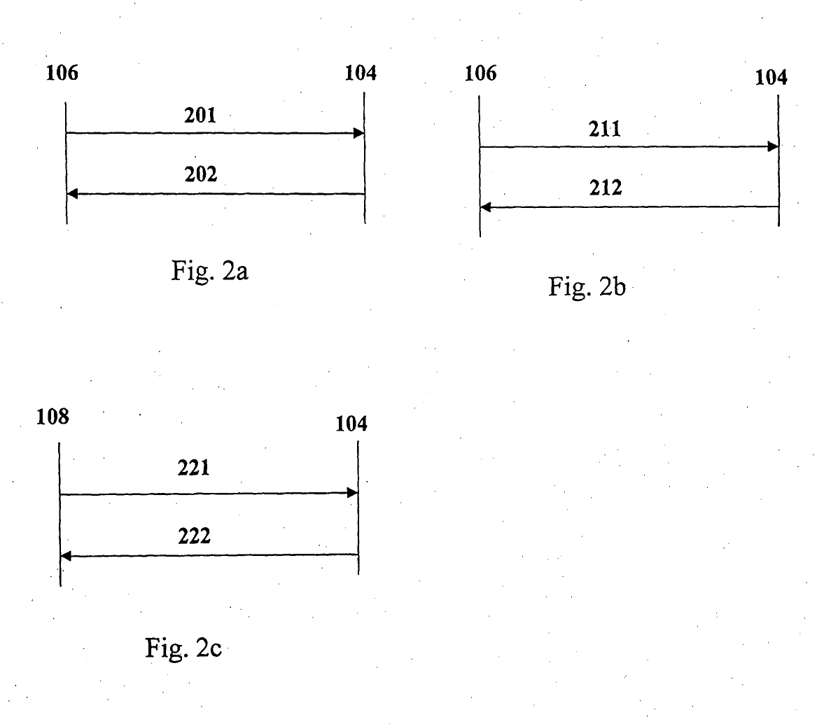

The proceedings when using the registry 104 with different levels of security will now be described more in detail referring to the signalling sequence diagrams in FIGS. 2-8

Using the Registry without Additional Certificates

Before storing anything in the registry, a registry entry must be created. This is shown in the signalling sequence diagram in FIG. 2a.

201 A “create an entry” command is sent from the user application 106; to the

registry 104.

202 An entry without restrictions is created in the registry 104 and an

acknowledgement is sent from the registry 104 to the user application 106.

FIG. 2b is a signalling sequence diagram showing how to store data, a so-called value, in a created entry in the registry.

211 A “write a value in the registry” command comprising the entry identity, the

name of the value and the value, is sent from the user application 106; to

the registry 104.

212 If successful writing to registry entry, the registry 104 will respond to the

user application 106 with an acknowledgement message, and if not

successful, with a non-acknowledgement message.

FIG. 2c is a signalling sequence diagram showing how to read data in a created entry in the registry. Anyone can read in an entry in the registry that not is restricted, but in this exemplary example, a first user application 106 has created an entry and stored a value in the created registry entry 104 and a second user application 108 wishes to read the value.

221 The second user application 108 sends a “read a value in the registry” command comprising the entry identity and the name of the value.

222 If the registry entry contains the relevant information, the registry 104 will send the requested value. If not, a non-acknowledgement is sent from the registry to the second user application 108.

Using the Registry with Additional Certificates

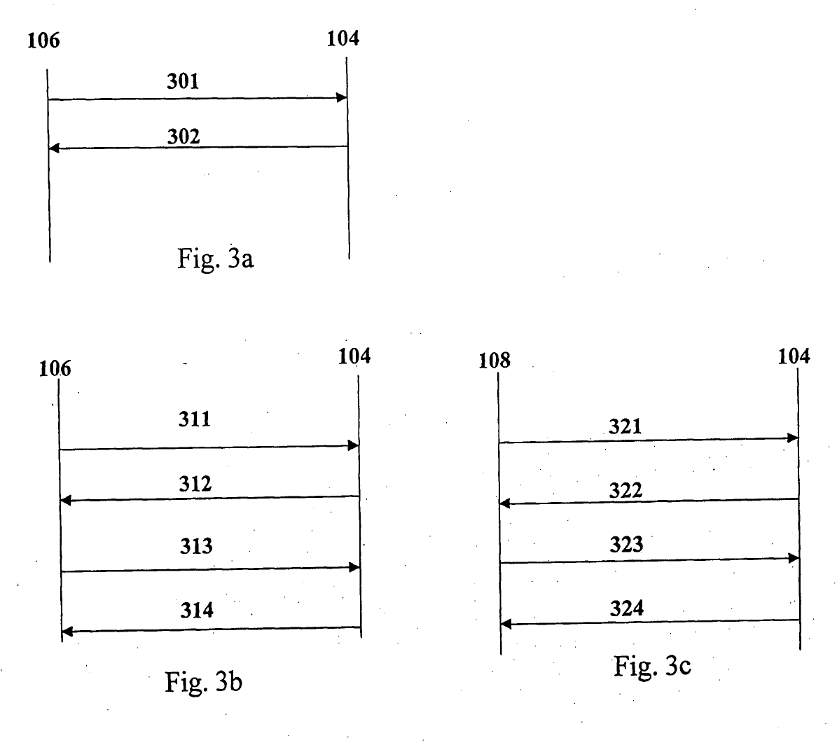

As mentioned above, a registry entry must be created before storing anything in the registry. This is shown in the signalling sequence diagram in FIG. 3a and is similar to the creating procedure in the non-restricted use described above.

301 A “create an entry in the registry” command is sent by the first user application 106 to the registry 104. The command comprises a list of the one or more root certificates requested to be associated to the entry.

302 A restricted entry with the requested associated root certificates is created in the registry 104 and an acknowledgement is sent from the registry 104 to the user application 106.

FIG. 3b is a signalling sequence diagram showing how to store data, a so-called value, in a created entry with restrictions i.e. an associated root certificate, in the registry.

311 A “write a value in the registry” command comprising the entry identity, a certificate that has been signed by a local certification authority (CA), the name of the value and the value, is sent by the first user application 106 to the registry 104.

312 The registry 104 verifies that the certificate specified in the “write a value in

the registry” command in step 311 is valid and if so the registry will

challenge the user application 106. This may be performed by creating a

random data and encrypting the random data with the public key of the

certificate specified in the “write a value in the registry” command in step

311. The encrypted data is sent to the first user application 106.

313 The first user application 106 decrypts the data and sends it back to the

registry 104.

314 The registry 104 verifies that the encrypted data has been decrypted

correctly. If the random data is the same as before the registry 104

encrypted it, the value is stored in the registry 104, otherwise a non-acknowledgement

is sent to the user application 106.

FIG. 3c is a signalling sequence diagram showing how to read data in a created entry in the registry restricted with an associated root certificate. Anyone can read in an entry in the registry that has got a valid certificate signed or issued by the owner of the root certificate The first user application 106 has created an entry associated with a root certificate in the registry 104, and stored a value in the created entry. The second user application 108 wishes to read the value.

321 The second user application 108 sends a “read a value in the registry”

command to the registry 104. The command comprises the entry identity, a

certificate that has been signed or issued by the owner of the root certificate

and the name of the requested value.

322 The registry 104 will now challenge the second user application 108. This

may be performed by creating a random data and encrypting it with the

public key, comprised in the certificate specified in the “write a value”

command in step 331. The encrypted data is sent to the second user

application 108.

323 The second user application 108 decrypts the data with its private key and

sends it back to the registry 104.

324 The registry 104 verifies that the encrypted data has been decrypted

correctly. If the random data is the same as before the registry 104

encrypted it, the requested value is sent to the second user application 108,

otherwise a non-acknowledgement is sent to it.

Using the Registry with Copy Protection

To be capable of storing a value copy protected the user application must download a certificate from the registry 104. It is assumed that the user application previously has created an entry with or without restrictions, both can be used.

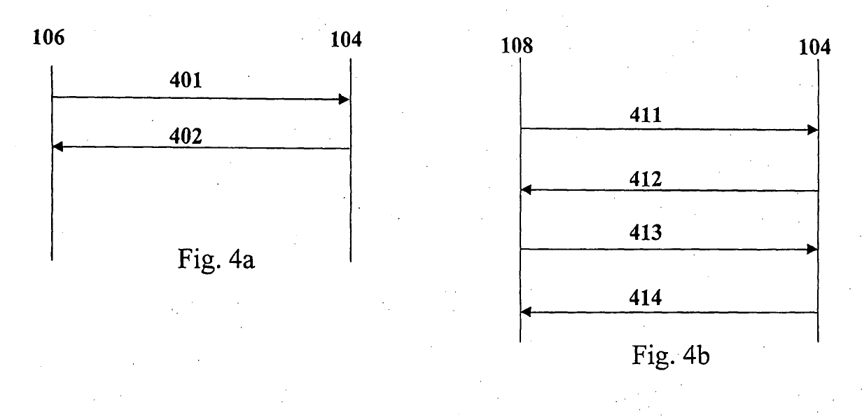

FIG. 4a is a signalling sequence diagram showing how to store data, a so-called value, copy protected in the registry such that a user application that reads the stored value can be sure that this is the original value and not a cloned one. This is suitable e.g. for storing electronic tickets (e-tickets). In that case the first user application 106 may be an e-ticket issuer, the registry 104 may be a smart card such as a SIM card in a mobile phone of a person that purchases and uses the e-ticket for some kind of event such as a film, and the second user application 108 may be a ticket receiver e.g. at a cinema, that collects the ticket from the person when he e.g. enters a cinema. The ticket receiver want to be sure that the e-ticket is the one that the person purchased from the ticket issuer and not a cloned copy that he got free of charge from his friend.

401 A first user application 106 combines the value, e.g. an e-ticket, to be stored with a certificate previously downloaded from the registry 104. The first user application 106 signs the value-certificate combination and sends a “write a value in the registry” command comprising the entry identity, the name of the value and the signed combination to the registry 104 for storing.

402 The registry stores the signed combination and sends an acknowledgement to the first user application 106 if the storing is successful, otherwise a non-acknowledgement.

FIG. 4b is a signalling sequence diagram showing how to find out that a read copy-protected value in the registry 104 it is not cloned or manipulated. The second user application 108 wishes to read the value.

411 The second user application 108 sends a “read a value in the registry” command comprising the entry identity, and the value name.

412 The registry returns the value to the second user application 108.

413 The second user application 108 validates the signature of the signed data, extracts the stored certificate and then challenges the registry. The challenge may be performed by encrypting a random number with the public key stored in the certificate and then sending the result to the registry 104.

414 The registry 104 decrypts the challenge data and sends the result to the second user application 108. If the result is the same as the encrypted random number sent to the registry 104 the value is regarded as not copied.

The method is implemented by means of a computer program product comprising the software code-means for performing the steps of the method. The computer program product is run on processing means stored in a smart card. The computer program is loaded directly or from a computer usable medium, such as a floppy disc, a CD, the Internet etc

The present invention is not limited to the above-described preferred embodiments. Various alternatives, modifications and equivalents may be used. Therefore, the above embodiments should not be taken as limiting the scope of the invention, which is defined by the appending claims.

1. A method for a user application (106) to get access to a registry (104) within a smart card,
creating an entry in the registry (104), which entry is associated with a root certificate, and which root certificate is signed and issued by a Certification Authority (CA) (110);
any user application (106) sending a request for access to the created entry in the registry (104), said request comprising a certificate issued and signed by said CA, said certificate including a public key, said public key corresponding to a private key that said any user application (106) owns;
the registry (104) challenging said any user application (106) by means of the obtained public key;
said any user application (106) responding said challenge by means of its said private key and returning it to the registry (104)
if the challenge response is successful, said any user application (106) given access to the created entry.

2. The method according to claim 1 wherein the step of creating an entry is performed by a first user application (106).

3. The method according the previous claim, wherein said any user application is the first user application (106) that has got access to the created entry for storing a value within said entry.

4. The method according the previous claim, wherein said any user application is a second user application (108) that has got access to the created entry for storing a value within said entry.

5. The method according to any of the claims 2-4, wherein said any user application is the first user application (106) that has got access to the created entry for reading a value stored in said entry.

6. The method according the any of the claims 2-4, wherein said any user application is a second user application (106) that has got access to the created entry for reading a value stored in said entry.

7. The method according the any of the previous claims, wherein a first value is to be stored in the created entry of the registry (104) such that the value cannot be copied or manipulated, the method comprising the further step of:
any user application (106) combining the first value to be stored with a certificate obtained from the registry (104),
the any user application (106) signing said value-certificate combination;
the any user application (106) sending said signed value-certificate combination to the registry to be stored in the created entry.

8. The method according to claim 7, wherein any user requires to read said first value, comprising the further step of:
any user application (106) obtaining said value-certificate combination, comprising the public key from the registry (104)
said any user application (106) challenging the registry (104) by means of the obtained public key;
the registry (104) responding said challenge by means of a private key that corresponds to the public key comprised in said certificate and returning it to said any user application (106)
if the challenge response is successful, the value is regarded as not copied or manipulated.

9. A computer program product directly loadable into the internal memory of a processing means within a smart card, comprising the software code means for performing the steps of any of the claims 1-8.

10. A computer program product stored on a computer usable medium, comprising readable program for causing a processing means within a smart card, to control an execution of the steps of any of the claims 1-8.

11. A smart card database registry (104) wherein any user application (106) may create an entry, which entry is accessible only for, by said any user application, selected user applications characterised in that the registry (104) comprises
means for creating an entry, which entry is associated with a root certificate, and which root certificate is signed and issued by a Certification Authority (CA) (110);
means for receiving a request for accessing the created entry in the registry (104) from any user. application (106), said request comprising a certificate issued and signed by the CA, said certificate including a public key, said public key corresponding to a private key that said any user application (106) owns;
means for using the obtained public key for challenging said any user application (106);
means for receiving a response of said challenge, encrypted by a private key of said any user application (106);
means for giving said any user application (106) access if the challenge response is successful.

12. The smart card database registry (104) according to claim 11, wherein it comprises means for storing a value in a created entry.

13. The smart card database registry (104) according to any of the claims 11-12, wherein it further comprises means for reading a value in the created entry.

14. The smart card database registry (104) according to any of the claims 11-13, wherein it comprises a public key and further, a certificate adapted for being sent to a user application requesting it, said certificate comprises a public key corresponding to said private key.

15. The smart card database registry (104) according to claim 13, wherein said means for storing a value in a created entry, for storing the value such that it can be checked by any user application reading the value whether it is copied or manipulated, comprises:
means for storing a so-called signed value-certificate combination received from any user application (106), the signed value-certificate combination comprising
a value to be stored combined with a certificate
which certificate said any user application (106) has obtained from the registry (104)
and which value-certificate combination is signed by said any user application (106).

16. The smart card database registry (104) according to claim 15, wherein the means for reading a value in the created entry comprises means for delivering said stored value-certificate combination, comprising the public key, to a user application (108) requesting it.

17. The smart card database registry (104) according to claim 15, wherein it further comprises means for responding a challenge from the user application (108) to which it delivered said stored value-certificate combination,
said challenge being encrypted by said user application (108) by means of the public key within the certificate,
and which challenge is responded by means of the public key corresponding to said certificate.

18. A smart card comprising the smart card registry (104) according to any of the claims 11-17.

19. A mobile terminal comprising the smart card according to claim 18.
